(19) United States
(12) Patent Application Publication
(10) Pub. No.: US 2005/0074660 A1
(43) Pub. Date: Apr. 7, 2005

(54) Three way valve assembly

(76) Inventors: James C. Linder, Shorewood, MN (US); Todd M. Ulschmid, New Prague, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/886,932

(22) Filed: Jul. 8, 2004

Related U.S. Application Data
(60) Provisional application No. 60/486,662, filed on Jul. 11, 2003.

(51) Int. Cl. H01M 8/02; H01M 2/08

(52) U.S. Cl. 429/38; 429/35; 429/13

(57) ABSTRACT

Improved three way valves comprise three openings aligned to directly connect with a corresponding series of ports and a selectively positionable seal that regulates the flow of a fluid within the valve. Improved fuel cells comprise a plurality of flow channels connected to at least one improved three way valve suitable for regulating fluid flow through the fuel cell. Generally, the flow channels comprise a series of ports, wherein the three way valve is configured to engage and disengage from the series of ports directly to form a manifold without the use of additional connectors, for example, tubes and/or hoses. Due to the fact that the three way valve can engage and disengage form the series of ports directly, potential leakage points in the fuel cell piping system can be reduced. In some embodiments, the three way valve comprises a central chamber having a selectively positionable seal, a bypass chamber and a through chamber. Generally, the selectively positionable seal can form a seal selectively at the port, or passage, connecting the central chamber with the bypass chamber or with the through chamber. The selectively positionable seal can regulate fluid flow from the central chamber to the bypass chamber and to the through chamber.

### CROSS-REFERENCE TO RELATED APPLICATIONS

The current application claims the benefit of priority from U.S. provisional patent application filed on Jul. 11, 2003, entitled “Three Way Valve Assembly” having Ser. No. 60/486,662, which is incorporated herein by reference.

### FIELD OF THE INVENTION

In general, this invention relates to three way valves with a desirable configuration. In particular, this invention relates to three way valves that can directly couple with corresponding structures, such as a fuel cell manifold. Additionally, the present invention relates to methods of controlling and/or regulating the flow of a fluid through a fuel cell.

### BACKGROUND OF THE INVENTION

In general, a fuel cell is an electrochemical device that can convent energy stored in fuels such as hydrogen, methanol and the like, into electricity without combustion of the fuel. A fuel cell generally comprises a negative electrode, a positive electrode, and a separator within an appropriate container. Fuel cells operate by utilizing chemical reactions that occur at each electrode. In general, electrons are generated at one electrode and flow through an external circuit to the other electrode to balance the chemical reactions. This flow of electrons creates an over-voltage between the two electrodes that can be used to drive useful work in the external circuit. In commercial embodiments, several “fuel cells” are usually arranged in series, or stacked, in order to create larger over-potentials.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. Additionally, fuel cells have several advantages over other sources of power that make them attractive alternatives to traditional energy sources. Specifically, fuel cells are environmentally friendly, efficient and utilize convenient fuel sources, for example, hydrogen or methanol.

As noted above, the fuel in a fuel cell can be replaced without disassembling the cell. Generally, the fuel in a fuel cell is a fluid such as, for example, hydrogen gas, which is pumped or circulated to the anode, while an oxidizing agent, such as air (oxygen), is delivered to the cathode. Additionally, reaction products are generally removed from the system. The delivery of appropriate reactants to the anode and the cathode, as well as the removal of reaction products, introduce specific fluid flow issues.

Fuel cells have potential uses in a number of commercial applications and industries. For example, fuel cells are being developed that can provide sufficient power to meet the energy demands of a single family home. In addition, prototype cars have been developed that run off of energy derived from fuel cells. Furthermore, fuel cells can be used to power portable electronic devices such as computers, phones, video projection equipment and the like. With the increasing number of fuel cell applications, it would be desirable to provide a fuel cell that could address the aforementioned problems.

### SUMMARY OF THE INVENTION

In a first aspect, the invention pertains to a three way valve comprising a central chamber having a selectively positionable seal and an opening to the exterior of the valve and a bypass chamber with a passage connecting the central chamber to the bypass chamber, wherein the bypass chamber has an opening to the exterior of the valve. In these embodiments, the three way valve further comprises a pass through chamber with a passage connecting the central chamber to the through chamber, wherein the through chamber has an opening to the exterior of the valve, and wherein the selectively positionable seal regulates fluid flow from the central chamber to the bypass chamber and to the through chamber. The openings respectively from the central chamber, the bypass chamber and the through chamber are roughly aligned in the same direction. Additionally, the three way valves can be used in methods of regulating the flow of a fluid through a fuel cell. In one embodiment, the method comprises providing a three way valve and adjusting the selectively positionable seal to regulate the fluid flow through the valve.

In second aspect, the invention pertains to a fuel cell comprising a cathode, an anode, an electrolyte and at least one three way valve for regulating fluid flow through the fuel cell comprising a valve body with three openings. In these embodiments, the fuel cell further comprises a rigid flow network, wherein the three way valve engages directly with the flow network.

In another aspect, the invention pertains to a fuel cell comprising a cathode, an anode and an electrolyte in contact with the anode and the cathode and at least one three way valve comprising a valve body having a central chamber, a bypass chamber, a through chamber, a first passage connecting the central chamber to the bypass chamber, a second passage connecting the central chamber to the through chamber, each chamber comprising a bore that forms an opening to the exterior of the valve body, and a selectively positionable seal that can seal the first passage or the second passage. In these embodiments, the fuel cell can further comprise a flow network comprising a fixed structure that has a fluid flow pathway to the anode or to the cathode, wherein the openings of the three way valve each engage directly with the fixed structure.

In a further aspect, the invention pertains to a three way valve comprising a valve body having a first chamber a second chamber and a third chamber, each chamber comprising a bore that forms an opening to the exterior of the valve body, the first chamber and the second chamber being connected by a first passage, the second chamber and the third chamber being connected by a second passage, wherein the openings form the first chamber, the second chamber and the third chamber are roughly aligned in the same direction. In these embodiments, the three way valve can further comprise a selectively positionable seal positioned within the second chamber having a sealing element which is adapted to engage the first passage or the second passage wherein the selectively positionable seal has a first position with the seal in contact with the first passage to seal the first passage and a second position with the seal in contact with the second passage to seal the second passage, and a control unit connected to the selectively positionable seal to control the position of the selectively positionable seal.

In still another aspect, the invention pertains to a method of regulating the flow of a fluid though a fuel cell, the fuel cell comprising a rigid flow network and a three way valve connected to the rigid flow network, the three way valve comprising a valve body having a central chamber, a bypass chamber having a first passage that connects the bypass chamber to the central chamber and a through chamber having a second passage that connects the central chamber to the through chamber, each chamber comprising a bore that forms an opening to the exterior of the valve body, and a selectively positionable seal that can regulate fluid flow through the three way valve. In these embodiments, the method can comprise adjusting the selectively positionable seal to regulate flow of a humidified fuel air mixture to an anode of the fuel cell.

### BRIEF DESCRIPTION OF THE FIGURES

FIG. 1 is a perspective view of an embodiment of a three way valve.

FIG. 2 is a bottom view of the three way valve of FIG. 1 showing a selectively positionable seal located in a central chamber.

FIG. 3 is a side view of the three way valve of FIG. 1.

FIG. 4 is a cross sectional view of the three way valve of FIG. 2 taken along line A-A of FIG. 2.

FIG. 5 is an exploded perspective view of the three way valve of FIG. 1 showing the components of the valve and solenoid.

FIG. 6 is a perspective view showing a three way valve directly attached to a fluid flow network.

FIG. 7 is a top view of the fluid flow network of FIG. 6.

FIG. 8 is a sectional view of the fluid flow network of FIG. 6 taken to show the flow pathways beneath the upper surface.

FIG. 9 is a schematic diagram showing a three way valve regulating fluid flow to a fuel cell stack.

### DETAILED DESCRIPTION OF THE INVENTION

Improved three way valves comprise three openings aligned to directly connect with a corresponding series of ports and a selectively positionable seal that regulates and/or directs the flow of a fluid within the valve. Improved fuel cells comprise a plurality of flow channels connected to at least one improved three way valve suitable for regulating fluid flow through the fuel cell. Generally, the flow channels comprise a series of ports, wherein the three way valve is configured to engage and disengage from the series of ports directly to form a manifold without the use of additional connectors, for example, tubes and/or hoses. Due to the fact that the three way valve can engage and disengage form the series of ports directly, potential leakage points in the fuel cell piping system can be reduced. In some embodiments, the three way valve comprises a central chamber having a selectively positionable seal, a bypass chamber and a through chamber. Generally, the selectively positionable seal can form a seal selectively at the port, or passage, connecting the central chamber with the bypass chamber or with the through chamber. The selectively positionable seal can regulate fluid flow from the central chamber to the bypass chamber and to the through chamber. In one embodiment, the selectively positionable seal can be actuated, for example, by a solenoid that is operably coupled to the selectively positionable seal.

The three way valves of the present disclosure are generally capable of directly connecting to a series of ports, without the need for adapters, such as tubes and/or hoses. In some embodiments, all three chambers of the three way valve are aligned with openings along a common plane. In other embodiments, the chambers are aligned with openings in different planes, however, in these embodiments the three way valve can still be directly connected to an appropriate series of ports to allow flow into both of the other chambers from central chamber. In one embodiment, a selectively positionable seal regulates the flow a fluid through the three way valve by obstructing the flow of fluid to one of the chambers. Specifically, the selectively positionable seal can be positioned to close off the bypass chamber from the central chamber, to close off the through chamber from the central chamber, or to allow flow into both of the other chambers from central chamber possibly with partial obstruction of the flow to either/or both sides.

As described above, the improved valves described herein comprise three aligned chambers each with a passage connecting the chamber with adjacent chambers and an opening to outside the valve. The shape of the chambers influences the character of the resulting flow through the valve. The orientation of the openings into the chambers provides for engagement of the valve with ports connected to appropriate flow channels. In general, the chambers are aligned in roughly the same orientation, and the openings into each chamber from outside the valve are similarly aligned in roughly the same orientation. While these rough relationships provide for the improved attachment of the valve, some variation can be tolerated without losing the improved aspect of the valve. In particular, it is the orientation of the three openings into the respective chambers that influences the attachment features of the valve.

In some embodiments, the openings into the respective chambers are coplanar. In other embodiments, the openings into the respective chambers are planar and along parallel planes, such that at least one of the openings extends below one or both of the other openings. More generally, while the openings are roughly oriented along the same direction, the outward normal to one of the openings can be at an angle relative to one or more of the other two openings. For convenience, the angles can be referenced to the outward normal of the plane along the central opening. The angle of the outward normal of the plane of the other two openings is generally less than about 75 degrees, in other embodiments less than about 50 degrees, in further embodiments less than about 30 degrees and in additional embodiments from about 5 degrees to about 25 degrees. A person of ordinary skill in the art will recognize that additional ranges of angles within these explicit ranges are contemplated and are within the present disclosure. In some embodiments, one or more openings may not be planar, such as undulating. For the nonplanar embodiments, the outward normal can be defined with a plane that passes approximately through the average of any undulations or the like. Roughly aligned, as used herein, with respect to the openings of the chambers, implies that the three way valve can be placed onto a fixed manifold with a single motion and fastened for use.

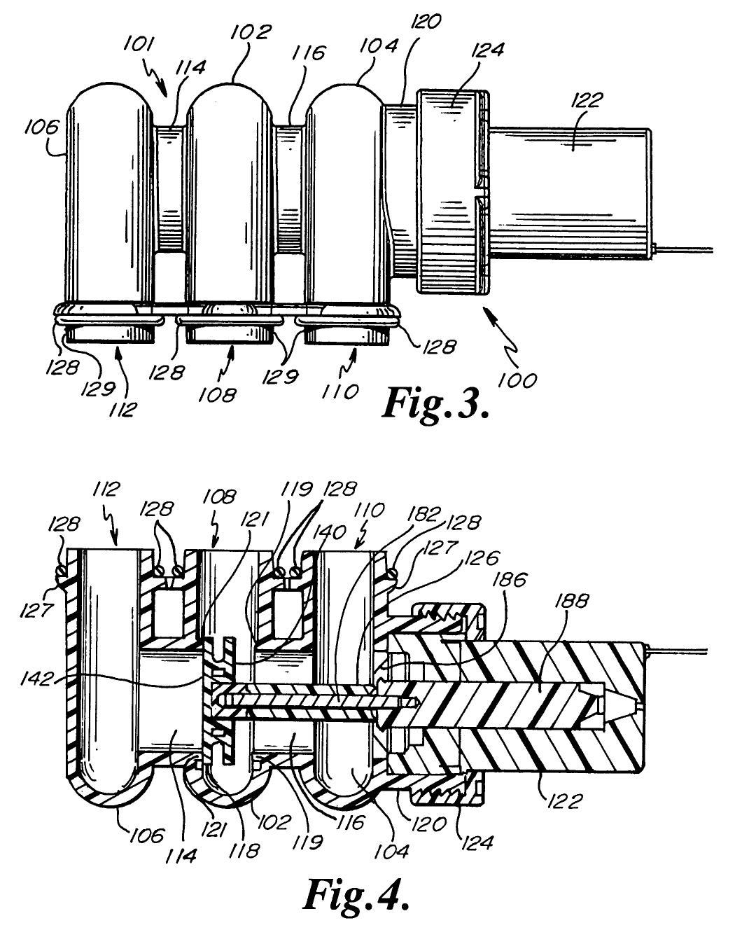

Referring to FIGS. 1-3, in one embodiment, three way valve 100 comprises valve body 101 having central chamber 102, bypass chamber 104 and through chamber 106. Generally, each chamber, 102, 104, 106 comprises openings 108, 110, 112, respectively, which can connect with an appropriate series of ports on, for example, a fuel cell or a fuel cell flow network. In some embodiments, the openings can be circular, while in other embodiments the openings can have an oval shape, a rectangular shape or the like. As shown in FIGS. 1-3, openings have an oval shape. One of ordinary skill in the art will recognize that additional shapes of the openings are contemplated and are within the scope of the present disclosure.

In one embodiment, as shown in FIGS. 1-3, openings 108, 110, 112 are all aligned in a common plane to facilitate direct connection to a series of ports. In some embodiments, the area of each opening is the same, while in other embodiments the area of the openings may be different. Generally, the size of each chamber and the area of the openings will be guided by the intended application and the associated fluid flow rates and pressure drop specifications. Such parameters can be evaluated by a person of ordinary skill in the art.

Referring to FIGS. 1-4, in some embodiments, chambers, 102, 104, 106 can further comprise flanges 127 and sealing members 128, which function to seal the chambers to an appropriate series of ports such as, for example, a fuel cell flow network, and prevent fluid leakage. Flanges 127 project outward adjacent openings 108, 110, 112 to leave lips 129. Sealing members 128 fit over lips 129 against flanges 127. Sealing members 128 can be composed of any sealing material suitable for use in fuel cell application including, for example, polymers, synthetic elastomers, natural rubbers and the like and combinations thereof which are inert in the particular fluid flow. In one embodiment, sealing members 118 can be composed of peroxide cured (ethylene propylene diene monomer) (EPDM).

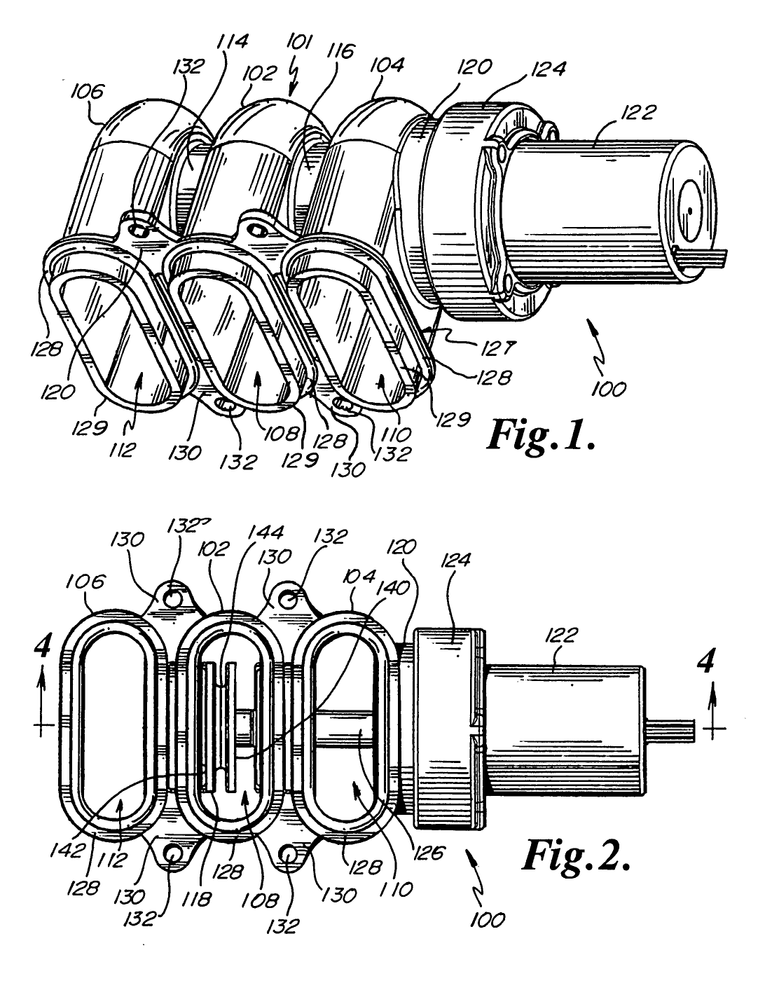

Additionally, in some embodiments, valve body 101 further comprises attachment sections 130 which are generally provided with fastener holes 132 for securing three way valve 100 to an appropriate series of ports via a mechanical fastener such as, for example, a screw or the like. Other fasteners can be substituted for fasteners and fastener holes 132 such as a clamp and suitable flanges or the like. As shown in FIGS. 1 and 2, in one embodiment, two attachment sections 130 are provided between through chamber 106 and central chamber 102, and two attachment section 130 are provided between central chamber 102 and bypass chamber 104. In one embodiment, attachment sections 130 comprise a substantially planer sections formed between two adjacent chambers of valve 100. Generally, attachment sections 130 are composed of the same material as the chambers of three way valve 100 and can be formed integrally with the chambers by, for example, injection molding. In general, valve body 101 can be formed as an integral unit comprising the three chambers 102, 104, 106 and the above described openings and ports.

Three way valve 100 further comprises passage 114 between through chamber 106 and central chamber 102, and passage 116 between central chamber 102 and bypass chamber 104. Passages 114, 116 permit fluids that enter central chamber 102 though opening 108 to flow to either and/or both ports 104, 106. Referring to FIG. 4, in some embodiments, valve seat 119 can be formed on passage 116, while valve seat 121 can be formed on passage 114. Referring to FIG. 2, in some embodiments, central chamber 102 further comprises selectively positionable seal 118, which can partially or completely obstruct either passage 114 or passage 116. As described below, selectively positionable seal 118 can regulate the flow of a fluid from central chamber 102 to either passage 114 or 116, which ultimately regulates the flow of a fluid from central chamber 102 to bypass chamber 104 and to through chamber 106.

Referring to FIG. 2, in one embodiment, selectively positionable seal 118 comprises a first surface 140 adapted to seal passage 116 and a second surface 142 adapted to seal passage 114. In embodiments employing valve seats 119, 121, first surface 140 can be adapted to engage valve seat 119 and second surface 142 can be adapted to engage valve seat 121, which can facilitate sealing of passage 114 and passage 116. Selectively positionable seal 118 can be a single element or a structure composed of a plurality of components. In some embodiments, first surface 140 and second surface 142 can be the same size, while in other embodiments first surface 140 and second surface 142 can have different sizes. Generally, the size and shape of selectively positionable seal 118 will be guided by the size and shape of passages 114, 116. For embodiments in which seal 118 comprises a plurality of components, selectively positionable seal 118 may further comprise a spacer 144 between first surface 140 and second surface 142. In some embodiments, the selectively positionable seal may be cylindrically symmetrical as well as symmetrical about a central plane perpendicular to the cylindrical axis, while in other embodiments the selectively positionable seal may have lower amounts of symmetry. In some embodiments, selectively positionable seal 118 can further comprise separate sealing elements, which prevent fluid leakage into the sealed passage, attached to spacer 144 at first surface 140, second surface 142, or both. In other embodiments, separate sealing elements can be located along the inner edges of passages 114, 116 such selectively positionable seal 118 can contact the sealing elements when the selectively positionable seal is positioned to block one of the passages. In one embodiment, the sealing element can be a polymeric covering or coating that prevents fluid flow around selectively positionable seal 118. Thus, if spacer 144 does not comprise an appropriate sealing material, the sealing elements along surfaces 140, 142 can provide a desired seal.

Generally, the first surface 140 and the second surface 142 of selectively positionable seal 118 can be composed of any material suitable for use in fluid transfer applications that is inert with respect to the fluid being transferred. Suitable materials include metals, metal alloys, polymers and combinations thereof. Suitable polymers include, for example, polyethylene, polypropylene, poly(tetrafluoroethylene), polyurethanes, poly(vinylidene fluoride) (PVDF) and blends and copolymers thereof. In one embodiment, first and second surfaces 140, 142 of selectively positional member 118 can be composed of a peroxide cured EPDM, while spacer 144 can be composed of PVDF. If a metal is used to form the selectively positionabie seal, then a separate sealing element, such as a polymeric coating described above, can generally be attached to the metal surface(s) to seal the passages. Suitable polymeric coatings that can be used for the sealing elements include, elastomers, natural rubbers, polyurethanes and the like and combinations thereof. In some embodiments, first surface 140 and second surface 142 are composed of the same material, while in other embodiments first surface 140 and second surface 142 may be composed of different materials.

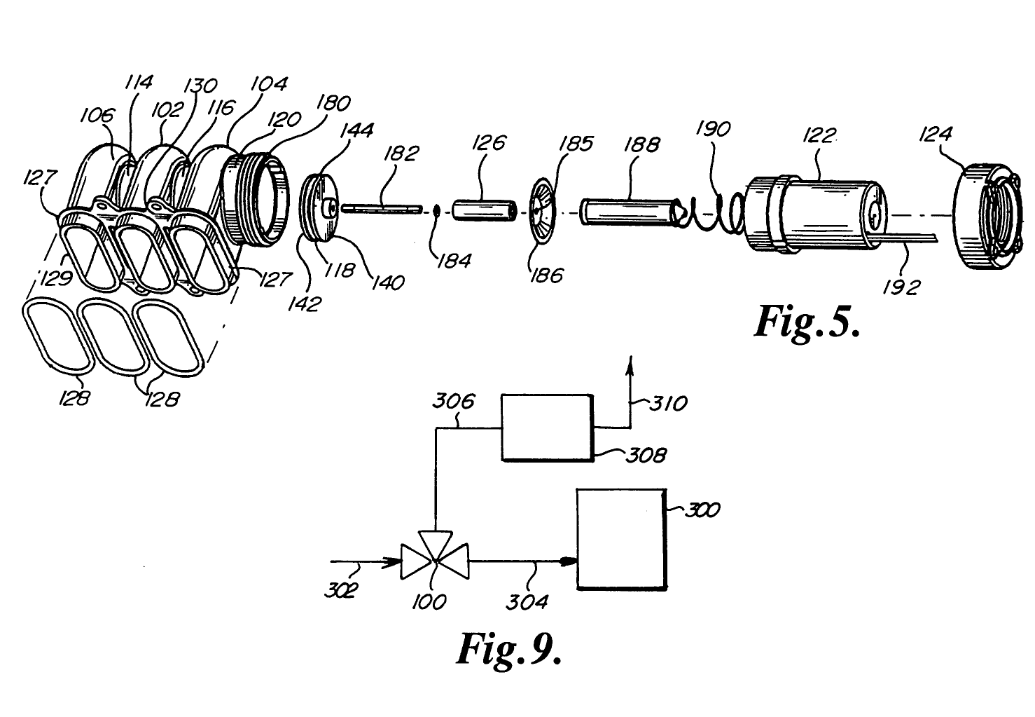

In some embodiments, valve 100 can further comprise coupling structure 120 which can interface with solenoid 122. FIG. 4 shows a cross sectional view taken along line A-A of FIG. 2. As shown in FIG. 4, passages 114, 116 connect through chamber 106 to central chamber 102 and central chamber 102 to bypass chamber 104, respectively. Selectively positionable seal 118 can be attached to diaphragm stem 126, which is further attached to solenoid plunger 188 by connecting rod 126. Referring to FIG. 5, a perspective view of three way valve 100 is shown, with the individual components of the solenoid system shown in exploded view. In one embodiment, coupling structure 120 comprises grooves 180 that can interface with corresponding structure on the inside surface of outer cap 124, which allows outer cap 124 to be secured to coupling structure 120. Outer cap 120 functions to secured solenoid 122 to coupling structure 120. As described above, selectively positionable seal 118 can be attached to diaphragm stem 126, which, in some embodiments, can be a hollow tube adapted to contain connecting rod 182. Additionally, connecting rod 182 generally penetrates through diaphragm 186 via diaphragm hole 185, and is attached to solenoid plunger 188 through an opening in solenoid plunger 188 adapted to receive connecting rod 182. Thus, connecting rod 182 functions to connect diaphragm stem 126, and selectively positionable seal 118, to solenoid plunger 188. In some embodiments, solenoid plunger 188 can be attached to compression spring 190, and compression spring 190 can be attached to solenoid 122.

In one embodiment, o-ring 184 can be used to attach connecting rod 182 with diaphragm stem 126. One of ordinary skill in the art will recognize that additional structures for connecting the connecting rod to the diaphragm stem are contemplated and are within the scope of the present disclosure. As shown in FIG. 5, in one embodiment, diaphragm 186 is a circular disk positioned between diaphragm stem 182 and solenoid plunger 186, and generally functions as a seal between coupling structure 120 of bypass port 104 and solenoid 122. FIG. 4 shows diaphragm 186 positioned to form a seal between the opening in coupling structure 120 and solenoid 122. Additionally, diaphragm 186 can also be distorted from a concave position to a convex position relative to the position of solenoid 122, as well as positions in between. Solenoid 122 further comprises electrical connections 192 which provides electricity for powering solenoid 122 and connections to a central processor unit designed to control the function of solenoid 122 during use of the valve 100. The central processor can control only the valve, all fluid flow of the integrated system (such as a fuel cell) and/or all functions of the integrated system (such as temperature control and electrical interface).

As will be described in detail below, the solenoid system can actuate selectively positionable seal 118 such that selectively positionable seal 118 can be positioned to completely seal either passage 114 or passage 116. In one configuration, solenoid 122 can extend selectively positionable seal 118 to contact the inner edges and/or valve seat 121 of passage 114, which can seal passage 114. In another configuration, solenoid 122 can retract selectively positionable seal 118 such that selectively positionable seal 118 can contact that inner edge and/or valve seat 119 of passage 116, which can and seal passage 116. Alternatively, selectively positionable seal 118 can be positioned between passage 114 and 116, partially obstruct either passage 114 or passage 116, which permits a percentage of the total fluid to flow through both passage 114 and passage 116. During operation, in one configuration, as shown in FIG. 4, selectively positionable seal 118 is positioned such that passage 114 is completely blocked, or sealed. When passage 114 is completely sealed by selectively positionable seal 118, fluid flowing, for example, into central chamber 102 through opening 108 will be directed through passage 116, into bypass chamber 104, and will exit three way valve 100 though opening 110. Conversely, when passage 116 is completely sealed by selectively positionable seal 118, fluid flowing into central chamber 102 will be directed through passage 114 into through chamber 106 and out opening 112. To actuate selectively positional member 118 during operation of three way valve 100, solenoid 122 can advance and retract solenoid plunger 188, which can cause diaphragm 186 to move between the convex and concave positions or in between positions. As described above, connecting rod 182 mechanically attaches diaphragm stem 126 to solenoid plunger 188 through diaphragm 186. Thus, as solenoid plunger 188 advances and distorts diaphragm 186, connecting rod and diaphragm stem are also advanced, which ultimately actuates selectively positionable seal 118 to an appropriate position to select the desired flow.

The chambers, coupling structure, solenoid housing, diaphragm stem, solenoid plunger and outer cap may be composed of any polymeric material suitable for use in fuel cell applications. Suitable polymers include, for example, polyethylene, ultra high molecular weight polyethylene (UHMWPE), poly(vinyl chloride), polycarbonates, poly(tetrafluoroethylene), polyurethanes, polypropylene, PVDF, and blends and copolymers thereof. The polymer should be selected such that it is chemically resistant to the fluids flowing through the valve and does not degrade under normal operating temperatures and pressures. Diaphragm 186 can be composed of any polymeric or elasotmeric composition with sufficient elasticity to permit the diaphragm to be converted from a convex position to a concave position. Suitable elastomers include, for example, natural rubbers, synthetic rubbers and the like and combinations thereof. In one embodiment, the diaphragm comprises a peroxide cured EPDM with a polyester fabric backing. In some embodiments, connecting rod can be composed of metal, such as steel, while in other embodiments connecting rod can be a polymeric material. In some embodiments, the o-rings can be composed of peroxide cured EPDM. In one embodiment, the compression spring can be composed of zinc coated music wire, however, other metal compression springs can also be employed. Various solenoids, and solenoid coils are commercially available. For example, one suitable commercially available solenoid coil is sold by Saia Burgess (Vandalia, Ohio). While solenoids are convenient, other motor types such as a stepper motor can be used to actuate seal 118. In general, the component pieces of the three way valve are produced and assembled to form the completed structure. As noted above, valve body can be integrally formed as a single structure by, for example, injection molding. The appropriate components of the solenoid system can be assembled and inserted into the valve body through the coupling structure. In one embodiment, the selectively positionable seal can be inserted through the opening in the central chamber and attached to the solenoid system. The outer cap can be connected to the coupling structure to secure solenoid system to the valve body.

In one embodiment, the three way valves of the present disclosure are suitable for use in fuel cell applications. As described above, a fuel cell generally comprises a anode, a cathode, a separator to electrically separate the anode and the cathode and an electrolyte, such as, for example, KOH, in an appropriate container. In a hydrogen fuel cell, hydrogen gas is supplied to the anode and air (oxygen) is supplied to the cathode. In these embodiments, hydrogen gas is ionized at the anode, which releases electrons and creates protons (H⁺ ions). The electrons are conducted through an external circuit anode to the cathode, where the electrons are involved in the reduction of molecular oxygen to form water. Thus, a hydrogen fuel cell generally requires a system capable of supplying the cathodes with oxygen (air) and the anodes with hydrogen. Example of fuel cells systems are disclosed in U.S. Pat. No. 6,451,467 to Peschke et al., entitled “Flow Control Subsystem for A Fuel Cell System,” and U.S. Pat. No. 5,648,182 to Hara et al., entitled “Fuel Cell Power Generation System,” which are hereby incorporated by reference.

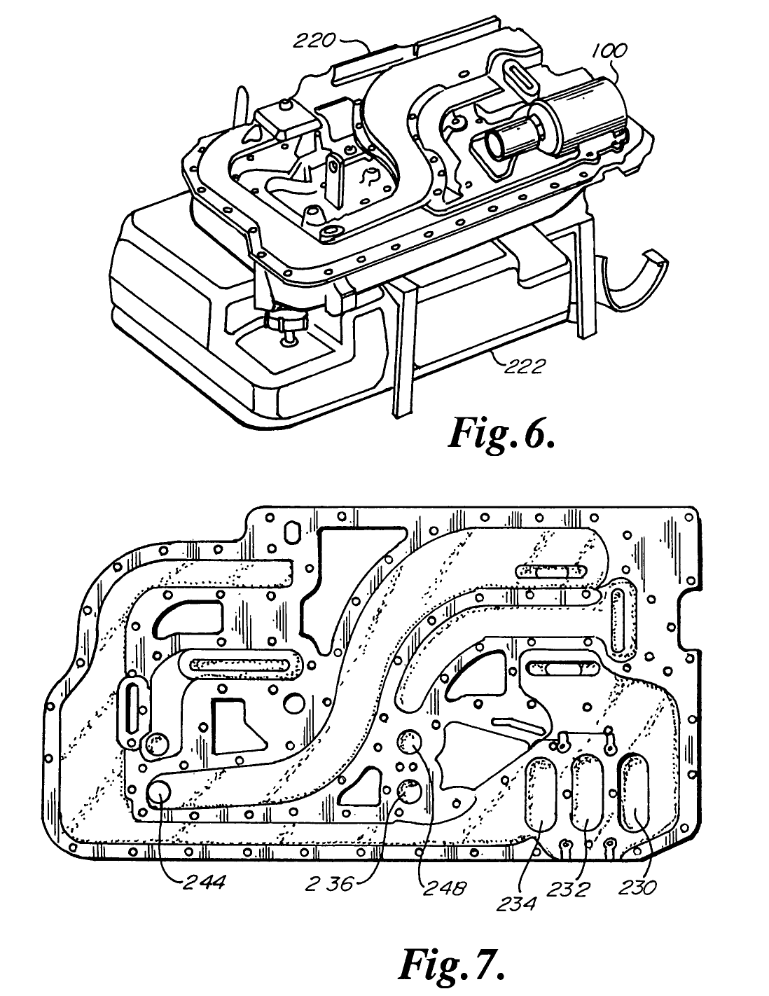

In one embodiment, as shown in FIG. 6, at least one three way valve 100 can be directly attached to a fluid flow network 220. Generally, the fluid flow network can be further attached to a portion of a fuel cell 222. As shown in FIG. 6, three way valve is directly coupled to fluid flow network 220 such that additional hoses and/or tubes are not necessary. In some embodiments, a fuel cell system can comprise two three way valves connected to each fluid flow network. One of the three way valves can be used to regulate and/or direct the flow of air, or another suitable gaseous oxidizing agent such as bromine, and the other three way valve can be used to regulate and/or direct the flow of a humidified fuel, such as a mixture of humidified hydrogen. As shown in FIG. 6, three way valve 100 directly connects to a unitary fluid flow network, however, in other embodiments three way valve 100 can directly connect to a fluid flow network that comprises a plurality of aligned flow segments.

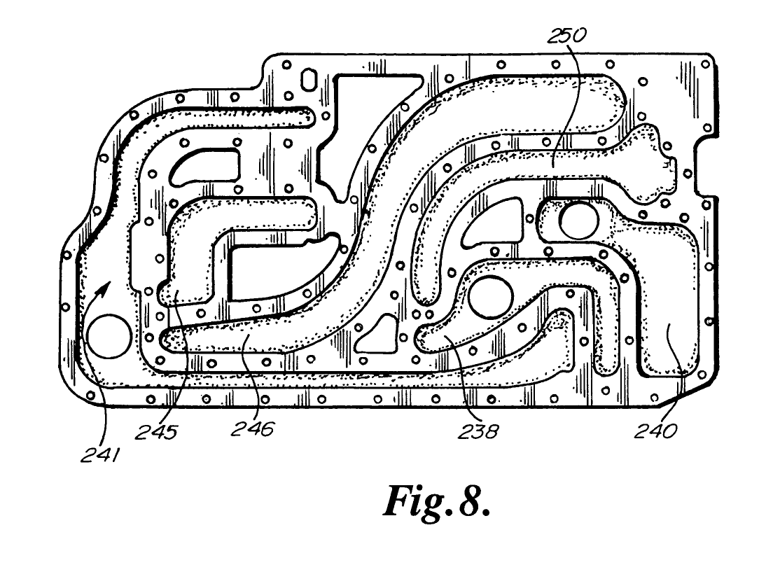

Referring to FIGS. 7 and 8, a top and sectional view, respectively, of fluid flow network 220 is shown. In some embodiments, fluid flow network 220 can comprise first port 230, second port 232 and third port 234, which can couple with through chamber 106, central chamber 102 and bypass chamber 104, respectively, of three way valve 100. First port 230, second port 232 and third port 234 are shown coupled with three way valve 100 in FIG. 6. As shown in FIGS. 7 and 8, anode fuel supply inlet 236 can be connected to anode fuel line 238 which can open into port 232, which can provide a flow pathway from inlet 236 to central chamber 102 of three way valve 100. Port 230, which can be connected to through chamber 106 of three way valve 100, can be connected to supply line 240, which can be further connected to the anode(s) of fuel cell to provide a fuel flow pathway from through port 106 to the anodes of a fuel cell stack. Additionally, port 234, which can be connected to bypass chamber 104 of three way valve 100, can be connected to by pass line 241, which provides a flow pathway from chamber 104 of three way valve 100 to an anode by pass system. Flow network 220 can also comprise cathode supply inlet 244 that is connected to cathode supply line 246, which can be further connected to the cathode(s) of a fuel cell stack to provide a flow pathway from inlet 244 to the cathodes. The cathodes of the fuel cell stack can also be connected to cathode exhaust line 245. In some embodiments, flow network 220 can further comprise coolant inlet 248 that can be connected to coolant line 250. Coolant inlet line 250 can further be connected to the fuel cell stack such that coolant introduced through coolant inlet 248 can flow through coolant line 250 into a fuel cell stack. As shown in FIGS. 6-8, flow network 220 and three way valve 100 are designed such that chambers 102, 104 106 on three way valve 100 can directly engage with ports 230, 232 and 234, respectively, of flow network 220 without the use of additional hoses and/or tubing.

During use, an anode fuel such as, for example, humidified hydrogen gas, can be introduced into anode fuel supply inlet 236 and can flow into central chamber 102 of three way valve through line 238. Once the gas is in central chamber 102, selectively positionable seal 118 can direct the flow of fluid to either through chamber 106 or bypass chamber 104. Additionally, in some embodiments, selectively positionable seal 118 can regulate the flow of fuel, or other fluids, such that a portion of the flow goes into through chamber 106 and a portion of the flow goes into bypass chamber 104. Fuel or other fluids that are directed into through chamber 106 can flow through port 230 into supply line 240 and can be directed to, for example, the anodes of a fuel cell stack. Additionally, fuel directed into by-pass chamber 102 can flow through port 234 into bypass line 241 where the fuel can be directed to a by pass system. Additionally, an oxidant such as, for example, air (oxygen) can be introduced into flow network 220 through inlet 244 and can flow through supply line 246 to the cathodes of a fuel cell stack. In one embodiment, selectively positionable seal 118 can be positioned to block the flow of fuel into through chamber 106 during start up and/or during an emergency shutdown of a fuel cell, which can reduce or eliminate the flow of fuel to the anodes of the fuel cell stack. Additionally, during normal steady state operation of a fuel cell, selectively positionable seal 118 can be positioned to block flow to by-pass chamber 104.

FIG. 9 shows a schematic diagram of three way valve 100 regulating fluid flow to fuel cell stack 300. As shown in FIG. 9, a fluid such as, for example, hydrogen fuel or air (oxygen) can be provided to three way valve 100 by input line 302. During normal operation, three way valve 100 can direct the flow of the fluid from line 302 to line 304, which is connected to fuel cell stack 300. During start up and/or an emergency shut down of the fuel cell, three way valve 100 can direct the flow of fluid form line 302 to line 306, which can be connected to, for example, a storage unit 308. Additionally, storage unit 308 can be provided with line 310 which can be connected to an exhaust system, if appropriate. For example, in embodiments where the flow of air (oxygen) is being regulated by valve 100, line 310 can be connected to an exhaust system that vents the oxygen stored in storage unit 308 to the ambient atmosphere. As described above, a fuel cell system can comprise a first three way valve to regulate fuel flow to the fuel cell stack and a second three way valve to regulate oxidant flow to the fuel cell stack. Additional three way valves may also be employed to regulate the flow tail gas exiting the fuel cell stack.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A fuel cell comprising:
a cathode,
an anode;
an electrolyte in contact with the anode and the cathode;
at least one three way valve comprising a valve body having a central chamber, a bypass chamber, a through chamber, a first passage connecting the central chamber to the bypass chamber, a second passage connecting the central chamber to the through chamber, each chamber comprising a bore that forms an opening to the exterior of the valve body, and a selectively positionable seal that can seal the first passage or the second passage; and
a flow network comprising a manifold structure that has a fluid flow pathway to the anode or to the cathode, wherein the openings of the three way valve each engage directly with the manifold structure.

2. The fuel cell of claim 1 wherein the bore of the openings of the three way valve have a circular cross-sectional shape.

3. The fuel cell of claim 1, wherein the bore of the openings of the three way valve have an oval cross-sectional shape.

4. The fuel cell of claim 1, wherein the valve body is composed of a polymer selected from the group consisting of polyethylene, ultra high molecular weight polyethylene (UHMWPE), poly (vinyl chloride), polycarbonates, poly(tetrafluoroethylene), polyurethanes, polypropylenes, poly (vinylidene fluoride), and blends and copolymers thereof.

5. The fuel cell of claim 1, wherein the openings respectively from the central chamber, the bypass chamber and the through chamber are aligned roughly in the same direction.

6. The fuel cell of claim 5, wherein the openings respectively from the central chamber, the bypass chamber and the through chamber are aligned in a substantially coplanar orientation.

7. The fuel cell of claim 1, wherein the central chamber further comprises a first valve seat formed on the first passage, and a second valve seat formed on the second passage.

8. The fuel cell of claim 1, wherein the selectively positionable seal further comprises a first sealing surface adapted to engage the first valve seat and a second sealing surface adapted to engage the second valve seat, wherein the first sealing surface can seal the first passage between the central chamber and the bypass chamber and the second sealing surface can seal the second passage between the central chamber and the through chamber.

9. The fuel cell of claim 7, wherein the first sealing surface and the second sealing surface are composed of a polymer selected from the group consisting of polyethylene, polypropylene, poly(tetrafluoroethylene), polyurethanes, poly(vinylidene fluoride), and blends and copolymers thereof.

10. The fuel cell of claim 8, wherein the first sealing surface and the second sealing surface are composed of polymer formed as a peroxide cured ethylene propylene diene monomer (EPDM).

11. The fuel cell of claim 1, wherein the selectively positionable seal is connected to a solenoid system which can move the selectively positionable seal between a position where the first sealing surface is in contact with the first valve seat to form a flow pathway from the central chamber to the through chamber, and a position where the second sealing surface is in contact with the second valve seat to form a flow pathway from the central chamber to the bypass chamber.

12. The fuel cell of claim 11, wherein solenoid system comprises a case, a solenoid, a compression spring, a solenoid plunger, a diaphragm having a diaphragm hole, a connecting rod, and a diaphragm stem having a hollow core adapted to contain the connecting rod, wherein the compression spring connects the case to the solenoid plunger and biases the solenoid plunger to a first position, wherein the connecting rod extends through the hollow core of the diaphragm stem and passes through the diaphragm hole to connect the diaphragm stem to the solenoid plunger, wherein the connection rod is also connected to the selectively positionable seal, and wherein current can be applied to the solenoid which generates a magnetic field that can actuate the solenoid plunger and the attached diaphragm stem and connection rod such that the selectively positionable seal can be moved to a second position.

13. The fuel cell of claim 11, wherein the bypass chamber further comprises a second opening formed substantially perpendicular to the bore in the bypass chamber, wherein the second opening is sized to receive the diaphragm of the solenoid system with the diaphragm stem within the valve body and the solenoid plunger on the outside of the valve body as divided by the diaphragm.

14. The fuel cell of claim 13, wherein the diaphragm is sized to fit into and seal the second opening in the bypass chamber.

15. The fuel cell of claim 12, wherein the diaphragm comprises a circular disk composed of a polymer formed as a peroxide cured ethylene propylene diene monomer (EPDM).

16. The fuel cell of claim 12, wherein the case of the solenoid comprises a flange and wherein the valve further comprises a cap having an opening adapted to extend over the case and engage the case flange wherein the cap engages the valve body to fasten the solenoid case to the valve body.

17. The fuel cell of claim 1, wherein the three way valve further comprises flange portions extending around the outside periphery of the openings on the central chamber, the bypass chamber and the through chamber, and wherein one or more sealing members extend around the outside periphery of the openings and contact the flange portions to prevent fluid leakage around the periphery of the openings when the openings are engaged with the fixed flow network.

18. The fuel cell of claim 17, wherein the one or more sealing members are composed of a polymer, a synthetic elastomer, natural rubber or a combination thereof.

19. The fuel cell of claim 1, wherein the valve body further comprises one or more attachment sections for securing the three way valve to the rigid flow network.

20. The fuel cell of claim 19, wherein the one or more attachment sections comprise substantially planar sections formed between adjacent chambers of the three way valve with holes and the fuel cell further comprising bolts extending through the holes to fasten the valve body to the rigid flow network.

21. The fuel cell of claim 1, further comprising a container that encloses the anode, cathode and the electrolyte, wherein the flow network forms a portion of the container.

22. The fuel cell of claim 1, further comprising an oxidant storage container in communication with the flow network to provide oxidizing agent to the flow network.

23. The fuel cell of claim 1, further comprising a fuel storage container in communication with the flow network to provide fuel to the flow network.

24. The fuel cell of claim 1 wherein the flow network comprises a fluid inlet line having a fluid inlet port and a central port, wherein the central port is coupled to the central chamber, and wherein the inlet line provides a fluid flow path-way for fluids from the fluid inlet port to the central chamber.

25. The fuel cell of claim 24 wherein the flow network further comprises a through port that engages with the through chamber, the through port opening into a fuel cell supply line that provides a flow passageway to a fuel cell stack.

26. A three way valve comprising:
a valve body having a first chamber a second chamber and a third chamber, each chamber comprising a bore that forms an opening to the exterior of the valve body, the first chamber and the second chamber being connected by a first passage, the second chamber and the third chamber being connected by a second passage, wherein the openings form the first chamber, the second chamber and the third chamber are roughly aligned in the same direction;
a selectively positionable seal positioned within the second chamber having a sealing element which is adapted to engage the first passage or the second passage wherein the selectively positionable seal has a first position with the seal in contact with the first passage to seal the first passage and a second position with the seal in contact with the second passage to seal the second passage; and
a control unit connected to the selectively positionable seal to control the position of the selectively positionable seal.

27. The fuel cell of claim 26, wherein the openings respectively from the first chamber, the second chamber and the third chamber are aligned roughly in the same direction.

28. The fuel cell of claim 27, wherein the openings respectively from the first chamber, the second chamber and the third chamber are aligned in a substantially coplanar orientation.

29. The fuel cell of claim 26, wherein the control unit comprises a solenoid system that selectively positions the selectively positionable seal.

30. The fuel cell of claim 29, wherein solenoid system comprises a case, a solenoid, a compression spring, a solenoid plunger, a diaphragm having a diaphragm hole, a connecting rod, and a diaphragm stem having a hollow core adapted to contain the connecting rod, wherein the compression spring connects the case to the solenoid plunger and biases the solenoid plunger to a first position, wherein the connecting rod extends through the hollow core of the diaphragm stem and passes through the diaphragm hole to connect the diaphragm stem to the solenoid plunger, wherein the connection rod is also connected to the selectively positionable seal, and wherein current can be applied to the solenoid which generates a magnetic field that can actuate the solenoid plunger and the attached diaphragm stem and connection rod such that the selectively positionable seal can be moved to a second position.

31. A method of regulating the flow of a fluid to an anode or a cathode, the fuel cell comprising a flow network and a first three way valve connected to the flow network, the first three way valve comprising a first valve body having a first central chamber, a first bypass chamber having a first passage that connects the first bypass chamber to the first central chamber and a first through chamber having a second passage that connects the first central chamber to the first through chamber, each chamber comprising a bore that forms an opening to the exterior of the first valve body, and a first selectively positionable seal that can regulate fluid flow through the three way valve, the method comprising:
adjusting the selectively positionable seal to regulate flow of a fluid to the anode or the cathode of the fuel cell.

32. The method of claim 31, wherein the openings on the central chamber, the bypass chamber and the through chamber are roughly aligned in the same direction.

33. The method of claim 31, wherein the fuel cell further comprises a second three way valve connected to the flow network, the second three way valve comprising a second valve body having a second central chamber, a second bypass chamber having a first passage that connects the second bypass chamber to the second central chamber and a second through chamber having a second passage that connects the second central chamber to them second through chamber, each second chamber comprising a bore that forms an opening to the exterior of the valve body, and a second selectively positionable seal that can regulate fluid flow through the second three way valve.

34. The method of claim 33, further comprising adjusting the first selectively positionable seal of the first three way valve to regulate flow of a fuel to the anode and adjusting the second selectively positionable seal of the second three way valve to regulate the flow of an oxidizing agent to a cathode.

35. The method of claim 31, wherein the flow network forms a portion of a container that encloses an anode, a cathode and an electrolyte.
